(19) United States
(12) Patent Application Publication
(10) Pub. No.: US 2026/0142477 A1
(43) Pub. Date: May 21, 2026

(54) INFORMATION HANDLING SYSTEM RECHARGEABLE MOUSE

(71) Applicant: Dell Products L.P., Round Rock, TX (US)

(72) Inventors: Zi Ming Lee, Austin, TX (US); Jace W. Files, Round Rock, TX (US); Emily Holub, Austin, TX (US); Anthony J. Sanchez, Pflugerville, TX (US)

(73) Assignee: Dell Products L.P., Round Rock, TX (US)

(21) Appl. No.: 18/952,422

(22) Filed: Nov. 19, 2024

(51) Int. Cl. H02J 7/35; G02B 19/00

(52) U.S. Cl. CPC H02J 7/35; G02B 19/0009; G02B 19/0042

(57) ABSTRACT

An information handling system mouse has a photovoltaic cell coupled in a casing interior that generates electric current from light passing from exterior the casing through a portion having at least partial transparency to the photovoltaic cell. A mirror placed below photovoltaic cell reflects light to the bottom of the photovoltaic cell to improve light harvesting efficiency. A lens above the photovoltaic cell and within the casing refracts light towards the photovoltaic cell to further enhance light harvesting efficiency.

### BACKGROUND OF THE INVENTION

### Field of the Invention

The present invention relates in general to the field of information handling system peripherals, and more particularly to an information handling system rechargeable mouse.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems process information with processing components that interface through input/output (I/O) devices. Stationary information handling systems couple a processor and memory in a stationary housing and interact through peripheral devices, such as a peripheral display, keyboard and mouse. Portable information handling systems integrate processing components, a display and a power source in a portable housing to support mobile operations. Portable information handling systems allow end users to carry a system between meetings, during travel, and between home and office locations so that an end user has access to processing capabilities while mobile. Portable information handling systems also will typically interact with peripheral I/O devices. The I/O devices may interface through a cable, such as a USB cable, or with wireless signals, such as BLUETOOTH. When interfaced through a USB cable, peripheral devices will typically run off power provided from the information handling system through the USB cable. When interfaced by wireless communication, power at the peripheral is typically provided by a battery.

Wireless peripherals offer end user's increased flexibility since the peripheral device is free from a tether. A difficulty with wireless peripherals is that the peripherals become unusable when the battery charge expires. Alkaline cell batteries can have a relatively long charge life, such as a year in the case of a typical mouse, however, the battery is disposable and creates waste. In addition, standard size disposable batteries tend to be large and heavy compared against rechargeable batteries. Rechargeable batteries, such as lithium ion batteries, tend to have a longer lifespan and smaller size but run down the charge in a relatively short time so that recharging is needed, such as every two weeks. One option to maintain a longer charge life is to include a photovoltaic cell on the peripheral device that recharges the battery by converting ambient light into current. Although a photovoltaic cell adds charge to a battery, in smaller form factor peripheral devices like a mouse the amount of charge tends to be too small to rely upon for running the mouse since the housing of the mouse lacks enough space at which the photovoltaic cell can be exposed to ambient light. In one example embodiment, a mouse that is actively used and includes power saving sleep modes can use 3.24 mWhr/day of power, while a conventional photovoltaic cell will only generate 2.02 mWhr/day with a 6 cm² photovoltaic cell; 2.99 mWhr/day with 8 cm²; and 3.71 mWhr/day with 10 cm².

### SUMMARY OF THE INVENTION

Therefore, a need has arisen for a system and method which improves photovoltaic charging of a mouse battery in a reduced footprint.

In accordance with the present invention, a system and method are provided which substantially reduce the disadvantages and problems associated with previous methods and systems for photovoltaic cell charging of a mouse battery. A photovoltaic cell is included in a mouse casing interior to harvest light passed through the casing and directed towards the photovoltaic cell with one or more of mirrors and lenses included in the casing.

More specifically, an information handling system executes instructions on a processor to process information in cooperation with a memory that stores the instructions and information. The instructions accept inputs from a peripheral mouse through wireless signals to control a cursor position presented at a display. The peripheral mouse has a casing with a hand rest portion at an upper side that is at least partially transparent to pass light from external the mouse to an interior, the light aligned with a photovoltaic cell that converts the light to current that powers the mouse. One or more mirrors coupled in the casing interior direct the light towards the photovoltaic cell to enhance light harvesting. In one example embodiment, the photovoltaic cell is raised above the mirror so that light that passes through the photovoltaic cell reflects back to the bottom side of the photovoltaic cell for harvesting. In another example embodiment, a lens included in the casing, such as integrated with the casing portion at the hand rest, directs light towards the photovoltaic cell.

The present invention provides a number of important technical advantages. One example of an important technical advantage is that a mouse includes a photovoltaic cell in the mouse casing interior to harvest light that powers the mouse, such as by charging a battery. The surface area of the photovoltaic cell that is needed to operate the mouse is reduced by improving the efficiency of light harvesting through the use of mirrors and lenses. An end user has an improved user experience with enhanced battery charge life and reduced need to charge the mouse in a small mouse casing.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exploded perspective view of an information handling system that accepts end user inputs through a peripheral mouse;

FIG. 2 depicts a block diagram of an information handling system mouse configured to harvest light energy with an internal photovoltaic cell bolstered by a mirror and lens;

FIG. 3 depicts an upper perspective view of a mouse configured to harvest light with an internal photovoltaic cell raised over a mirror;

FIG. 4 depicts an upper perspective view of a mouse configured to harvest light directed at a photovoltaic cell with angle mirrors;

FIGS. 5 and 5A depict an upper perspective and side view of a mouse configured to harvest light directed at a photovoltaic cell with a graded index lens; and

FIGS. 6 and 6A depict an upper perspective and side view of a mouse configured to harvest light directed at a photovoltaic cell with a curved Fresnel lens.

### DETAILED DESCRIPTION

An information handling system mouse has a mirror and/or lens in a casing interior to improve the effectiveness of light harvesting by a photovoltaic cell coupled in the mouse casing. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

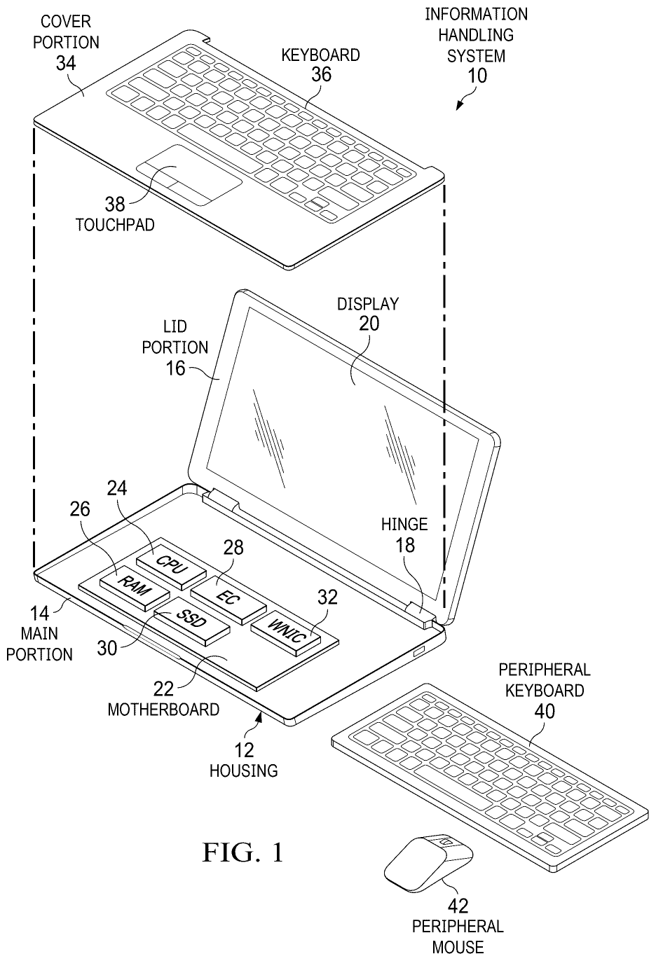

Referring now to FIG. 1, an exploded perspective view depicts an information handling system 10 that accepts end user inputs through a peripheral mouse 42. In the example embodiment, information handling system 10 has a portable housing 12 with a main portion 14 rotationally coupled to a lid portion 16 by a hinge 18. In alternative embodiments, a stationary information handling system may be used. A display 20 integrates in lid portion 16 to present information as visual images. Processing components coupled to a motherboard 22 in main portion 14 cooperate to process information, such as with an operating system and applications executing as instructions on a central processing unit (CPU) 24 executed in cooperation with storage on a random access memory (RAM) 26. An embedded controller 28 manages operations of the processing components, such as application of power and communication with peripheral devices. A solid state drive (SSD) 30 stores the instructions and information in non-transitory memory. A wireless network interface controller (WNIC) 32 communicates with external devices through a radio and wireless signals, such as by BLUETOOTH and WIFI. A housing cover portion 34 couples over the processing components in main portion 14 and supports an integrated keyboard 36 and touchpad 38 that accept end user inputs to CPU 24.

Information handling system 10 interacts with an end user through peripheral input devices that include a peripheral keyboard 40 and a peripheral mouse 42. Inputs detected at the peripheral devices are communicated by wireless signals from the peripheral device to the embedded controller through wireless radio signals supported by WNIC 32, such as BLUETOOTH. The inputs and wireless communication are powered by a battery in the peripheral device that is recharged, in part, by a photovoltaic cell included in an interior of the peripheral device. Power consumption is managed by transitioning between active, idle and sleep states at the peripheral device depending upon end user interactions at the peripheral device. In order to minimize the footprint of the photovoltaic cell, mirrors and lenses included in the peripheral device help to increase the efficiency with which light energy is harvested, as described in greater detail below.

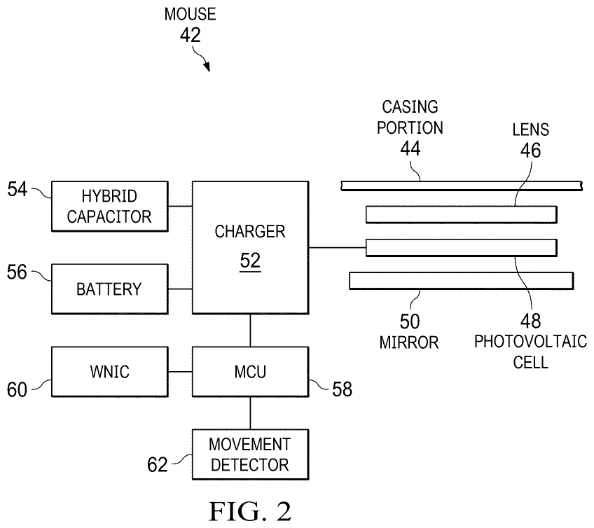

Referring now to FIG. 2, a block diagram depicts an information handling system mouse 42 configured to harvest light energy with an internal photovoltaic cell 48 bolstered by a mirror 50 and lens 46. A casing portion 44 of the casing that encases the mouse is at least partially transparent to pass light from external the mouse to the interior of the mouse. The amount of opaqueness of the casing may vary based upon the degree to which the interior of the mouse casing is intended to be hidden or visible. Light that passes through casing portion 44 is focused by a lens 46 so that a larger area of the casing exterior collects light that is directed at a smaller footprint photovoltaic cell 48. Photovoltaic cell 48 is a bifacial cell that passes some light through. Mirror 50 coupled under photovoltaic cell 48 reflects light back at the bottom side of the photovoltaic cell both for light that passed through the cell and other light that is focused by the mirror to direct at the bottom side of the photovoltaic cell. Light harvested by the photovoltaic cell generates an electric current communicated to a charger 52 that stores the charge in a hybrid capacitor 54 and/or a battery 56. For example, the mouse may include only a battery, only a hybrid capacitor, or both a battery and a hybrid capacitor to store power. As the mouse enters an active state, power from the battery and hybrid capacitor are communicated to a microcontroller unit (MCU) 58 that executes instructions to communicate through WNIC 60 pointer commands determined from a movement detector 62, such as laser directed at a desktop that detects movement of the casing relative to the desktop.

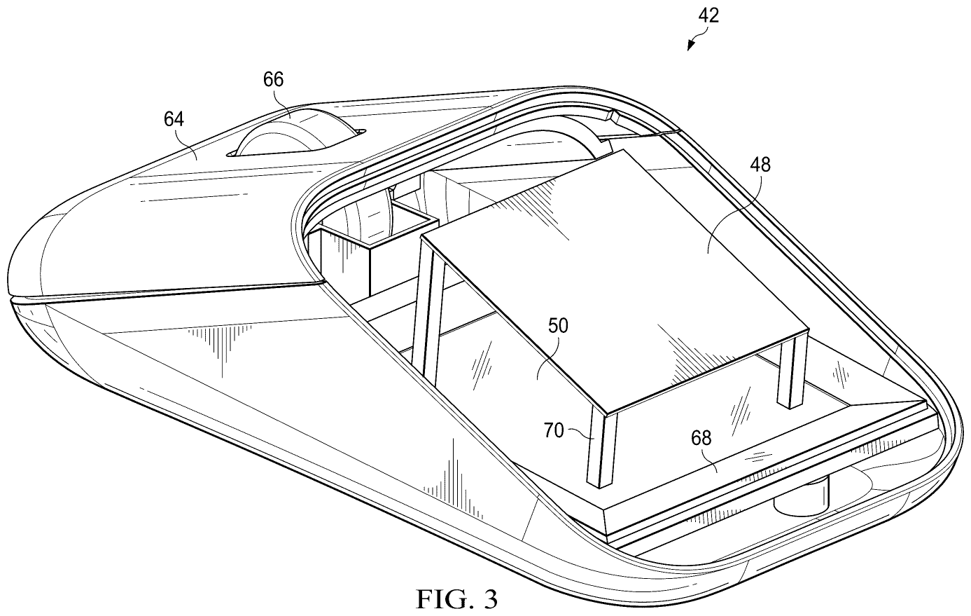

Referring now to FIG. 3, an upper perspective view depicts a mouse 42 configured to harvest light with an internal photovoltaic cell 48 raised over a mirror 50. Mouse 42 is assembled in an outer casing 64 having a scroll wheel 66 extending from the top front side, such as between input buttons. A hand rest, shown in FIG. 2, is removed where the casing portion couples in place and has at least some transparency to pass light through and towards photovoltaic cell 48. For instance, the hand rest is a semitransparent plastic material that hides the mouse internal components while allowing light to enter through the casing portion. A stand 70 holds photovoltaic cell 48 in a raised position above a mirror 50, such as reflective finish on a printed circuit board that reflects ambient light at the underside of photovoltaic cell 48. Photovoltaic cell 48 is bifacial to allow light harvesting of the reflected light. An angled mirror frame 68 around mirror 50 helps to direct additional light towards the bottom side of photovoltaic cell 48. In various embodiments, other mirrors may be added to the interior of casing 64 so that light is directed at the photovoltaic cell.

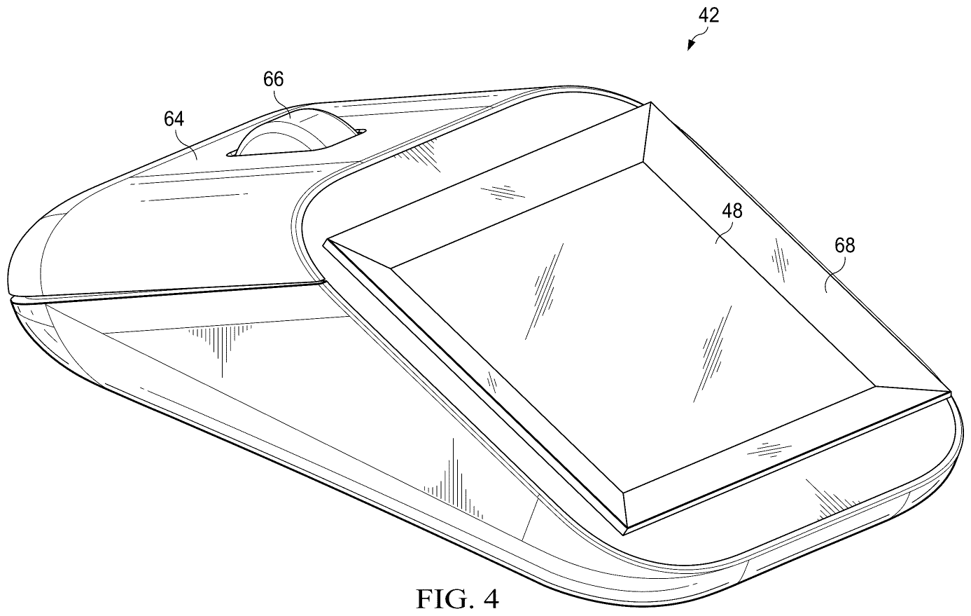

Referring now to FIG. 4, an upper perspective view depicts a mouse 42 configured to harvest light directed at a photovoltaic cell with angle mirrors. A casing 64 encloses a movement detector and scroll wheel 66 as described above. The hand rest portion of casing 64 is removed to show a photovoltaic cell 48 that harvests light to generate current as described above. An angled mirror frame 68 couples in casing 64 around photovoltaic cell 48 to direct ambient light at photovoltaic cell 48. In the example embodiment, a mirror may also couple under photovoltaic cell 48 as shown in FIG. 3. In one example embodiment, the mirror for redirecting light at the photovoltaic cell is integrated in the casing portion so that the mirror assembles in place when the casing portion hand rest is coupled in place to casing 64 over the photovoltaic cell.

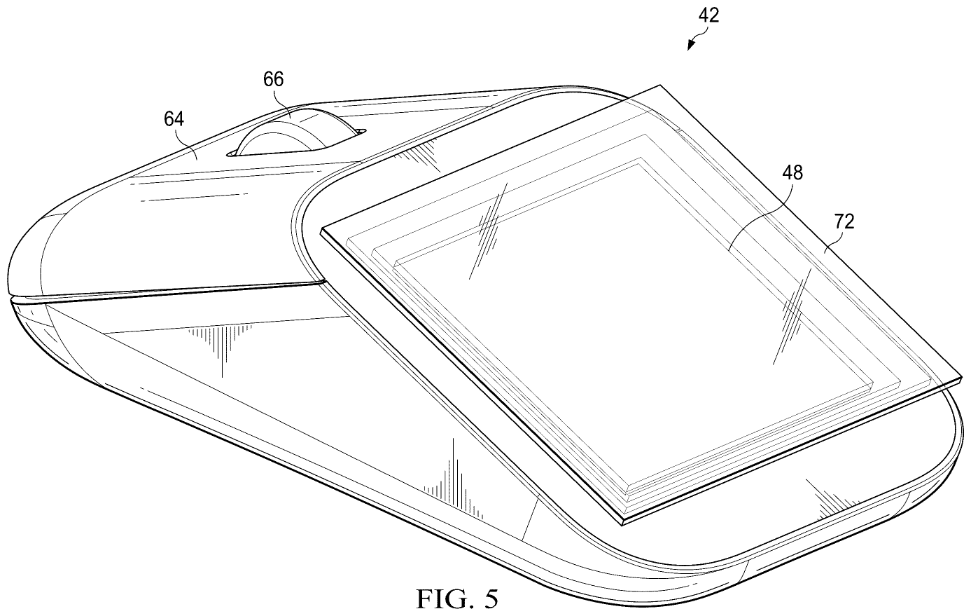

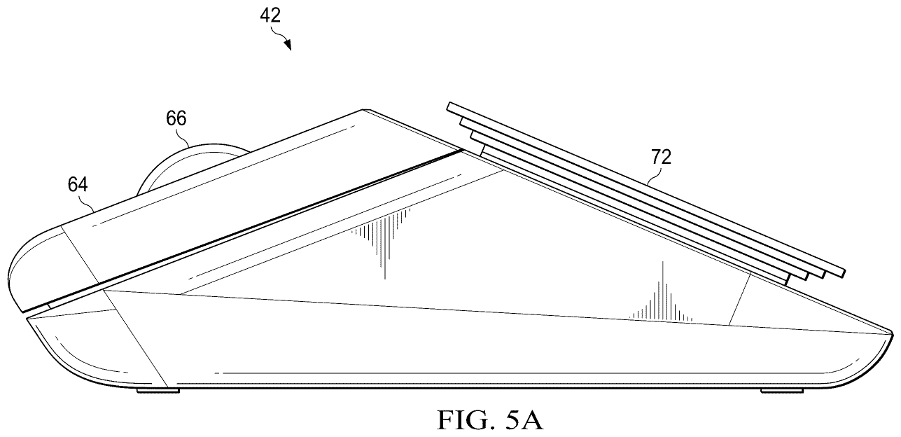

Referring now to FIGS. 5 and 5A, an upper perspective and side view depicts a mouse 42 configured to harvest light directed at a photovoltaic cell 48 with a graded index lens 72. FIG. 5A depicts a side view of graded index lens 72 showing axially graded layers of glass or other transparent material that captures light by refraction from multiple angles to direct the light towards photovoltaic cell 48. In the example embodiment, photovoltaic cell 48 is at the base of the graded index lens to accept light that is redirected by refraction through the lens. In addition, photovoltaic cell 48 may couple over a mirror so that light that passes through the photovoltaic cell is reflected back at the bottom side of the photovoltaic cell to be harvested. In one example embodiment, the lens is integrated in the casing portion at the hand rest so that the full surface area of the hand rest gathers light that is directed to the photovoltaic cell.

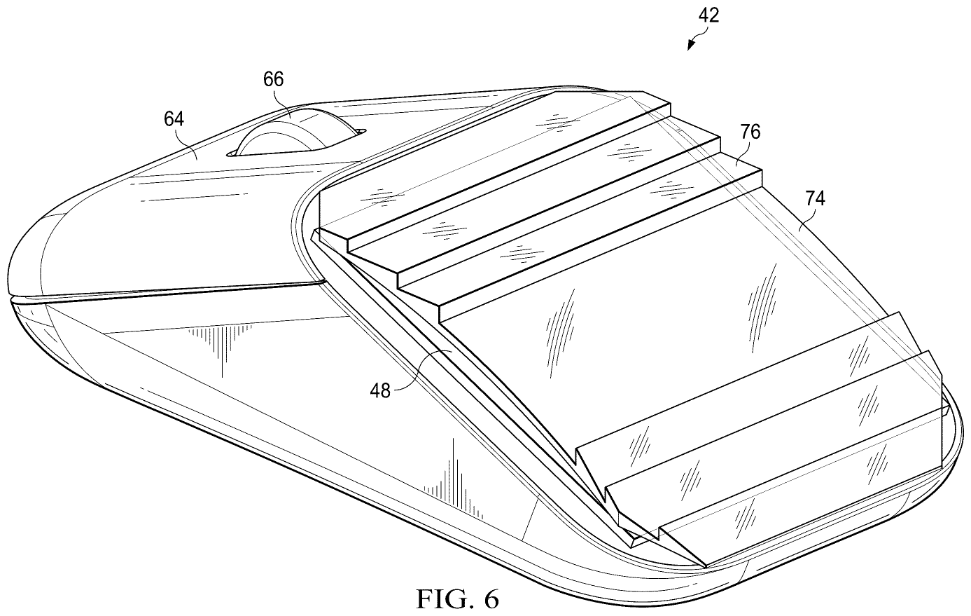

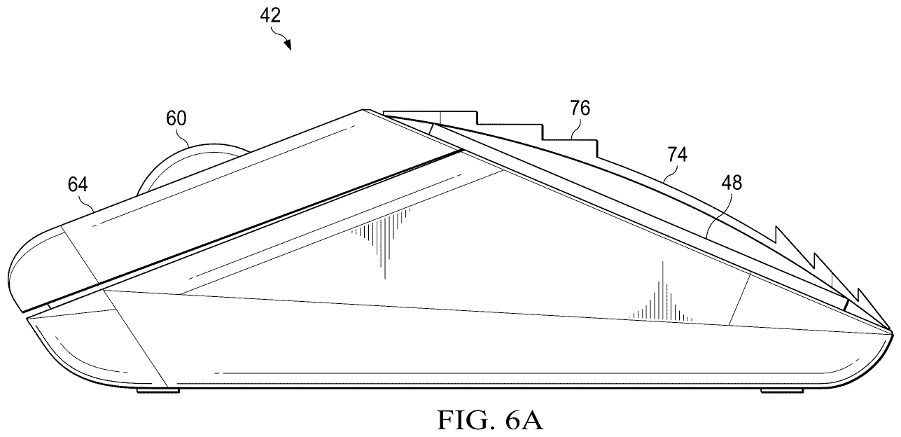

Referring now to FIGS. 6 and 6A, an upper perspective and side view depict a mouse 42 configured to harvest light directed at a photovoltaic cell with a curved Fresnel lens 74. FIG. 6 depicts curved Fresnel lens 74 coupled in the opening of casing 64 at the hand rest location where the casing portion couples in place. Ridges 76 formed in the top and bottom upper side of curved Fresnel lens 74 help to refract incident light perpendicular to the lens onto the sloped underlying photovoltaic cell 48. FIG. 6A depicts a side view showing the convex curve of the lens and ridges aligned to direct light towards the photovoltaic cell. The lens is formed to capture as much light as possible and spread the light across the photovoltaic cell so that light harvesting is optimized. As is described above, a mirror under the photovoltaic cell may reflect the light back at the bottom side of the photovoltaic cell to further enhance light harvesting. Although the example embodiments described above relate to light harvesting at a mouse, in alternative embodiments, the mirrors and lenses may be included in an interior of a keyboard or other peripheral to help maintain the battery charge.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor coupled in the housing and operable to execute instructions to process information;
a memory coupled in the housing and interfaced with the processor, the memory operable to store the instructions and information;
a wireless network interface controller operable to communicate by wireless signals; and
a peripheral mouse having a casing, a battery coupled in the casing, a charger coupled in the casing and operable to charge the battery, and a photovoltaic cell coupled in the casing and operable to convert light into electric current applied to the charger, the casing having a portion with at least partial transparency aligned with a photovoltaic cell to pass ambient light external the casing through the portion and at the photovoltaic cell in the casing interior.

2. The information handling system of claim 1 further comprising:
a mirror coupled in the mouse casing interior; and
a platform coupled in the mouse casing interior, the photovoltaic cell coupled to the platform and held over the mirror.

3. The information handling system of claim 2 wherein the photovoltaic cell comprises a bifacial material that converts light reflected from the mirror through the photovoltaic cell and towards the portion having at least partial transparency into electrical current.

4. The information handling system of claim 3 further comprising an angled reflective frame around the mirror configured to direct reflected light towards the photovoltaic cell.

5. The information handling system of claim 4 wherein the casing portion having at least partial transparency comprises a hand rest at the upper surface of the mouse.

6. The information handling system of claim 4 further comprising an axially graded lens coupled between the photovoltaic cell and the casing to refract light entering through the casing towards the photovoltaic cell.

7. The information handling system of claim 4 further comprising a curved Fresnel lens coupled between the photovoltaic cell and the casing to refract light entering through the casing towards the photovoltaic cell.

8. The information handling system of claim 7 further comprising plural ridges formed in the Fresnel lens to refract light towards the photovoltaic cell.

9. The information handling system of claim 7 wherein the curved Fresnel lens integrates with the casing.

10. A method for powering an information handling system mouse, the method comprising:
coupling a photovoltaic cell in an interior of a mouse casing;
passing light from an exterior of the mouse casing to the photovoltaic cell through a portion of the casing having at least partial transparency; and
converting the light to an electrical current to power the mouse.

11. The method of claim 10 further comprising:
coupling a mirror in the casing interior; and
coupling the photovoltaic cell raised above the mirror between the mirror and the portion of the casing having at least partial transparency.

12. The method of claim 11 further comprising coupling an angled reflective frame around the mirror configured to direct reflected light towards the photovoltaic cell.

13. The method of claim 11 further comprising coupling an axially graded lens between the photovoltaic cell and the casing to refract light entering through the casing towards the photovoltaic cell.

14. The method of claim 13 further comprising integrating the axially graded lens in the casing at a hand rest of the casing.

15. The method of claim 11 further comprising coupling a curved Fresnel lens between the photovoltaic cell and the casing to refract light entering through the casing towards the photovoltaic cell.

16. A mouse comprising:
a casing;
a movement detector coupled in the casing and operable to detect movement of the casing as cursor pointer inputs;
a wireless network interface controller interfaced with the movement detector and operable to communicate the cursor pointer inputs as wireless signals;
a hybrid capacitor interfaced with the movement detector and the wireless network interface controller to provide power to the movement detector and the wireless network interface controller; and
a photovoltaic cell coupled in an interior of the casing and interfaced with the hybrid capacitor, the photovoltaic cell operable to convert into electrical current light passing from exterior the casing into the interior.

17. The mouse of claim 16 further comprising:
a mirror coupled in the mouse casing interior; and
a platform coupled in the mouse casing interior, the photovoltaic cell coupled to the platform and held over the mirror.

18. The mouse of claim 17 further comprising an angled reflective frame around the mirror configured to direct reflected light towards the photovoltaic cell.

19. The mouse of claim 17 further comprising an axially graded lens coupled between the photovoltaic cell and the casing to refract light entering through the casing towards the photovoltaic cell.

20. The mouse of claim 17 further comprising a curved Fresnel lens coupled between the photovoltaic cell and the casing to refract light entering through the casing towards the photovoltaic cell.
